(19) United States
(12) Patent Application Publication
(10) Pub. No.: US 2014/0072546 A1
(43) Pub. Date: Mar. 13, 2014

(54) COMPOSITIONS AND METHODS FOR ENHANCING INSECTICIDAL SEED TREATMENT EFFICACY

(71) Applicant: Valent U.S.A. Corporation, Walnut Creek, CA (US)

(72) Inventors: Karen Arthur, Plano, TX (US); Jay Stroh, Underwood, MN (US)

(73) Assignee: Valent U.S.A. Corporation, Walnut Creek, CA (US)

(21) Appl. No.: 14/080,144

(22) Filed: Nov. 14, 2013

(51) Int. Cl. A01N 63/00; A01N 47/44

(52) U.S. Cl. CPC A01N 63/00; A01N 47/44
USPC 424/93.461

(57) ABSTRACT

The invention provides a method of enhancing insecticidal seed treatment efficacy comprising combining a neonicotinoid and a strain of Bacillus thuringiensis. The invention also provides a composition comprising a neonicotinoid and a strain of Bacillus thuringiensis.

### FIELD OF INVENTION

The present invention is directed toward compositions containing the bacteria Bacillus thuringiensis and a neonicotinoid insecticide. The present invention is also directed to methods of controlling Dipteran larvae and to methods of enhancing insecticidal seed treatment efficacy by the application of Bacillus thuringiensis to a neonicotinoidal seed treatment.

### BACKGROUND OF THE INVENTION

Seeds are commonly treated with pesticides to control insects, nematodes, and disease organisms such as fungi and bacteria. Neonicotinoids are commonly used as active ingredients in insecticidal seed treatments. Neonicotinoids function by attacking the central nervous system of insects and their larvae via pathways that are more abundant in insects than other animals. As a result, neonicotinoids are relatively safe for other animals. Among the commercially available neonicotinoid compounds are clothianidin (tradenames Poncho® and Nipslt® INSIDE), imidacloprid (tradename Gaucho®), thiamethoxam (tradename Cruiser®), and dinotefuran (tradename Safari®).

Another strategy for controlling insects and fungal infestations involves the use of biopesticides. Biopesticides are naturally occurring pathogens and/or the substances produced by these pathogens. One such biopesticide is Bacillus thuringiensis. Bacillus thuringiensis is a motile, rod-shaped, gram-positive bacterium that is widely distributed in nature, especially in soil and insect-rich environments. During sporulation, Bacillus thuringiensis produces a parasporal crystal inclusion(s). These crystal inclusions are insecticidal to susceptible insect larvae. The insecticidal effect occurs when the endotoxin proteins are converted into active compounds in the insect gut, which destroy the gut epithelium and ultimately the pest itself.

There are several Bacillus thuringiensis strains that are widely used as biopesticides in the forestry, agricultural, and public health areas. A delta-endotoxin specific for Diptera is produced by Bacillus thuringiensis subsp. israelensis (Goldberg, 1979, U.S. Pat. No. 4,166,112); Bacillus thuringiensis subsp. kurstaki and Bacillus thuringiensis subsp. aizawai produce delta-endotoxins specific for Lepidoptera; and Bacillus thuringiensis subsp. tenebrionis (Krieg et al., 1988, U.S. Pat. No. 4,766,203) produces a delta-endotoxin specific for Coleoptera.

Insecticides are applied by various methods including in-furrow, foliar and seed treatments. In-furrow treatment includes placing granules of insecticide in the soil shortly before, during or shortly after seed planting. In-furrow treatment can be accomplished several ways but the cost of the equipment and danger to the environment are high for each. Foliar treatment includes spraying the plant itself sometime after emergence from the soil. Foliar treatments are subject to spreading to undesired areas via strong winds or improperly calibrated equipment. Seed treatment includes applying the insecticide directly to the seed prior to planting. This application can be done in an enclosed environment without exposure of the worker or surrounding area to the insecticide. Despite its disadvantages in-furrow, granular treatment is currently superior to foliar and seed treatments utilizing neonicotinoids for control of Dipteran larvae, especially in areas of extreme pressure.

One plant that is greatly affected by Dipteran larvae is sugarbeet. Sugarbeet is responsible for 20% of the world's sugar production per year and the creation of many jobs in the United States. Sugarbeet yield is measured by the amount of sucrose that can be obtained from the root, normally from 12 to 20% of the total weight with the greater yield being the most desired. Growers must protect the sugarbeet from a variety of pests that will decrease this yield including viral disease, weeds, nematodes and a variety of insects, including those of the order Diptera. Female dipteran flies tend to lay their eggs very close to the food source that will be consumed. After hatching, which occurs directly after egg laying or while still within the mother, the larvae grow rapidly and consume relatively large amounts of food. The majority of Dipteran larvae are referred to as maggots. Maggots have many useful functions in society such as timing death in corpses, cleaning wounds, and even cheese softening and maturation. But, by and large, maggots are pests for many plants. Liriomyza spp. (leafminers), Delia platura (seedcorn maggot), and Tetanops myopaeformis (sugarbeet root maggots) are Dipteran larvae that pose grave problems for the farming of sugarbeets.

The sugarbeet root maggot, a Dipteran larva of the fly, Tetanops myopaeformis, is the most serious pest of the sugarbeet. The sugarbeet root maggot causes damage to the plant by using rasping mouthhooks to grate away the outside of the root. The result is death to seedlings and black, ooze emitting gashes on adult plants resulting in decreased yield and sucrose content. Control of the sugar beet root maggot has been problematic and it is currently found in over half the acreage in the United States.

Therefore, there is a need in the art for a safe insecticidal seed treatment that is as effective as the more costly and dangerous in-furrow, granular insecticides at controlling Dipteran larvae, such as the sugar beet root maggot. Ideally, the insecticidal seed treatment would exceed the level of control exhibited by in-furrow, granular insecticides.

### SUMMARY OF THE INVENTION

The present invention provides agricultural compositions and methods of enhancing insecticidal seed treatment efficacy comprising combining a neonicotinoid and a strain of Bacillus thuringiensis.

In one embodiment, the neonicotinoid is clothianidin.

In another embodiment, the strain of Bacillus thuringiensis is from subspecies israelensis (Bti).

In another embodiment, the Bti strain is AM65-52.

In another embodiment, the present invention provides a composition comprising clothianidin and Bacillus thuringiensis subspecies, israelensis, strain AM65-52.

In another embodiment, the present invention provides a method of controlling Dipteran larvae comprising applying a larvacidally-effective amount of a composition comprising a neonicotinoid and a strain of Bacillus thuringiensis to a seed.

In another embodiment, the Dipteran larvae are sugarbeet root maggots.

In another embodiment, the seeds are sugarbeet seeds.

The disclosed embodiments are simply exemplary embodiments of the inventive concepts disclosed herein and should not be considered as limiting, unless so stated.

### DETAILED DESCRIPTION OF THE INVENTION

The present invention generally relates to a method of enhancing insecticidal seed treatment efficacy comprising combining a neonicotinoid and a strain of Bacillus thuringiensis.

Applicants have discovered that the addition of a strain of Bacillus thuringiensis to a neonicotinoid when treating seeds enhances the insecticidal effect.

Neonicotinoids that can be used in accordance with this invention include but are not limited to clothianidin, imidacloprid, thiamethoxam, acetamiprid, dinotefuran, nitenpyram, and thiacloprid.

Strains of Bacillus thuringiensis that can be used in accordance with this invention include but are not limited to strains of subspecies kurstaki, subspecies aizawai, subspecies tenebrionis and subspecies israelensis; including but not limited to subspecies kurstaki, strain ABTS-351, SA-11 and SA-12 and subspecies israelensis, strain AM65-52.

In one embodiment, the neonicotinoid is clothianidin and the strain of Bacillus thuringiensis is AM65-52 of subspecies israelensis.

The invention further relates to a composition comprising a neonicotinoid and a strain of Bacillus thuringiensis.

The invention further relates to a method of controlling Dipteran larvae comprising applying a larvicidally-effective amount of a composition comprising a neonicotinoid and a strain of Bacillus thuringiensis to seeds. Techniques of seed treatment application are well known to those skilled in the art, and they may be readily used in the context of the present invention.

In another embodiment, a composition comprising a neonicotinoid and a strain of Bacillus thuringiensis would be used to treat the seeds of sugarbeets to control sugarbeet root maggots.

The invention further relates to methods of increasing sugarbeet yield by applying clothianidin and Bacillus thuringiensis subspecies israelensis (Bti), strain AM65-52 to sugarbeet seeds.

In one embodiment, the invention is directed to methods of increasing sugarbeet yield by applying clothianidin and Bacillus thuringiensis to sugarbeet seeds wherein the amount of clothianidin is from about 0.25% to about 75% by weight of total formulation. Preferably, the amount of clothianidin is from about 20% to about 60% by weight of total formulation. In a more preferred embodiment, the amount of clothianidin is from about 46% to about 49% by weight of total formulation. In a most preferred embodiment, the amount of clothianidin is about 48% by weight of total formulation.

In a further embodiment, the invention is directed to methods of increasing sugarbeet yield by applying clothianidin and Bacillus thuringiensis to sugarbeet seeds wherein the amount of clothianidin that is applied is from about 1 to about 1,000 grams of active ingredient (gai) per 100,000 seeds (unit seed). Preferably, clothianidin is applied from about 10 to about 100 grams of active ingredient (gai) per 100,000 seeds (unit seed). In a more preferred embodiment, clothianidin is applied from about 40 to about 80 grams of active ingredient (gai) per 100,000 seeds (unit seed). In a most preferred embodiment, the amount of clothianidin that is applied is about 60 grams of active ingredient (gai) per 100,000 seeds (unit seed).

In yet another embodiment, the invention is directed to methods of increasing sugarbeet yield by applying clothianidin and Bacillus thuringiensis to sugarbeet seeds wherein the amount of Bacillus thuringiensis is from about 1 to about 600,000 international toxic units (ITU) per milligram (mg). Preferably, the amount of Bacillus thuringiensis is from about 100 to about 5,000 international toxic units (ITU) per milligram (mg). In a more preferred embodiment, the amount of Bacillus thuringiensis is from about 100 to about 1,200 international toxic units (ITU) per milligram (mg). In a most preferred embodiment, the amount of Bacillus thuringiensis is about 1,200 international toxic units (ITU) per milligram (mg). It is also preferred that the Bacillus thuringiensis that is applied with clothianidin is subspecies israelensis, and specifically strain AM65-52.

In another embodiment, the invention is directed to methods of increasing sugarbeet yield by applying clothianidin and Bacillus thuringiensis to sugarbeet seeds wherein the Bacillus thuringiensis is applied at an amount from about 1 to about 1,000 million international toxic units (ITU) per milligram (mg). Preferably, the amount of Bacillus thuringiensis is from about 10 to about 500 million international toxic units (ITU) per milligram (mg). In a more preferred embodiment, the Bacillus thuringiensis is applied at an amount from about 100 to about 200 million international toxic units (ITU) per milligram (mg). In a most preferred embodiment, the Bacillus thuringiensis is applied at about 150 million international toxic units (ITU) per milligram (mg). It is also preferred that the Bacillus thuringiensis that is applied with clothianidin is subspecies israelensis, and specifically strain AM65-52.

As used herein, all numerical values relating to amounts, weights, and the like, that are defined as “about” each particular value is plus or minus 10%. For example, the phrase “about 5% by weight” is to be understood as “4.5% to 5.5% by weight.” Therefore, amounts within 10% of the claimed value are encompassed by the scope of the claims.

As used herein, “insecticidal seed treatment” is to be construed broadly and is defined as any application of an insecticide or insecticidal agent directly to the seed prior to or during planting.

As used herein, “enhancing” refers to increasing the insecticidal ability of the seed treatment.

As used herein, the phrase “larvicidally-effective amount” refers to the amount sufficient to control the population of a target pest.

As used herein, “control the population of a target pest” refers to maintaining the population of the target pest at a rate per plant such that the plant is viable and produces an agriculturally useful product.

As used herein, “controlling Dipteran larvae” refers to maintaining a Dipteran larva population at a rate per plant such that the plant is viable and produces an agriculturally useful product.

The following example is intended to illustrate the present invention and to teach one of ordinary skill in the art how to use the invention. It is not intended to be limiting in any way.

### EXAMPLE

Treatment of Seeds With a Neonicotinoid and Bacillus thuringiensis Composition

NipsIt® INSIDE, a clothianidin based insecticide, could be applied as a seed treatment at a rate of 60 gai per unit seed with 1,200 ITU per mg of Bacillus thuringiensis subspecies insraelensis, strain AM65-52 (Bti) at a rate of 37.5 million ITU per unit seed and 150 million ITU per unit seed. This combination could be prepared by any methods known by one of skill in the art. Other clothianidin based insecticides and Bacillus Thuringiensis could be used in the combination.

The resulting formulation could be applied to seeds in any manner deemed appropriate by one of skill in the art. Further, the rates of the clothianidin based insecticide and Bacillus thuringiensis can be adjusted as deemed appropriate by one of skill in the art.

What is claimed is:

1. An agricultural composition comprising a neonicotinoid and a strain of Bacillus thuringiensis.

2. An agricultural composition of claim 1, wherein the neonicotionid is clothianidin.

3. An agricultural composition of claim 1, wherein the strain of Bacillus thuringiensis is of the subspecies israelensis.

4. An agricultural composition of claim 1, wherein the strain of Bacillus thuringiensis is subspecies israelensis, strain AM65-52.

5. A method of enhancing insecticidal seed treatment efficacy comprising applying an effective amount of the composition of claim 1 to a seed.

6. The method of claim 5, wherein the neonicotinoid is clothianidin.

7. The method of claim 5, wherein the strain of Bacillus thuringiensis is of the subspecies israelensis.

8. The method of claim 5, wherein the strain of Bacillus thuringiensis is subspecies israelensis, strain AM65-52.

9. The method of claim 5, wherein the neonicotinoid is clothianidin and the strain of Bacillus thuringiensis is subspecies israelensis, strain AM65-52.

10. A method of controlling Dipteran larvae comprising applying a larvicidally-effective amount of the composition of claim 1 to a seed.

11. The method of claim 10, wherein the Dipteran larvae are sugarbeet root maggots.

12. The method of claim 10, wherein the seeds are sugarbeet seeds.

13. A method of increasing sugarbeet yield by applying clothianidin and Bacillus thuringiensis subspecies israelensis, strain AM65-52 to sugarbeet seeds, wherein:
i. the amount of clothianidin is from about 0.25% to about 75% by weight of total formulation; and
ii. the amount of Bacillus thuringiensis subspecies israelensis, strain AM65-52 is from about 1 to about 600,000 international toxic units (ITU) per milligram (mg).

14. The method of claim 13, wherein:
i. the amount of clothianidin is from about 20% to about 60% by weight of total formulation; and
ii. the amount of Bacillus thuringiensis subspecies israelensis, strain AM65-52 is from about 100 to about 5,000 international toxic units (ITU) per milligram (mg).

15. The method of claim 13, wherein:
i. the amount of clothianidin is from about 46% to about 48% by weight of total formulation; and
ii. the amount of Bacillus thuringiensis subspecies israelensis, strain AM65-52 is from about 100 to about 1,200 international toxic units (ITU) per milligram (mg).

16. The method of claim 13, wherein:
i. the amount of clothianidin is about 47.8% by weight of total formulation; and
ii. the amount of Bacillus thuringiensis subspecies israelensis, strain AM65-52 is about 1,200 international toxic units (ITU) per milligram (mg).

17. The method of claim 13, wherein:
i. clothianidin is applied at an amount from about 1 to about 1,000 grams of active ingredient (gai) per 100,000 seeds (unit seed); and
ii. Bacillus thuringiensis subspecies israelensis, strain AM65-52 is applied at an amount from about 1 to about 1,000 million international toxic units (ITU) per milligram (mg).

18. The method of claim 13, wherein:
i. clothianidin is applied at an amount from about 10 to about 100 grams of active ingredient (gai) per 100,000 seeds (unit seed); and
ii. Bacillus thuringiensis subspecies israelensis, strain AM65-52 is applied at an amount from about 10 to about 500 million international toxic units (ITU) per milligram (mg).

19. The method of claim 13, wherein:
i. clothianidin is applied at an amount from about 40 to about 80 grams of active ingredient (gai) per 100,000 seeds (unit seed); and
ii. Bacillus thuringiensis subspecies israelensis, strain AM65-52 is applied at an amount from about 100 to about 200 million international toxic units (ITU) per milligram (mg).

20. The method of claim 13, wherein:
i. clothianidin is applied at about 60 grams of active ingredient (gai) per 100,000 seeds (unit seed); and
ii. Bacillus thuringiensis subspecies israelensis strain AM65-52 is applied at about 150 million international toxic units (ITU) per milligram (mg).
